(19) United States
(12) Patent Application Publication
(10) Pub. No.: US 2005/0071762 A1
(43) Pub. Date: Mar. 31, 2005

(54) Apparatus and method for displaying photo and video data and recording medium containing a program for performing the same method

(75) Inventors: Du-il Kim, Suwon-si (KR); Young-yoon Kim, Seoul (KR); Vladimir Portnykh, Croydon (GB)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/949,253

(22) Filed: Sep. 27, 2004

Related U.S. Application Data
(60) Provisional application No. 60/505,625, filed on Sep. 25, 2003.

(30) Foreign Application Priority Data
Nov. 12, 2003 (KR) 10-2003-0079855

(51) Int. Cl. H04N 5/44; H04N 7/173; G11B 27/00

(52) U.S. Cl. 715/719

(57) ABSTRACT

An apparatus and method for displaying multimedia data described according to a MusicPhotoVideo (MPV) format. In the apparatus, it is checked whether an asset selected by a user is comprised of single photo data and one or more video data, reference information needed for displaying the photo data and the one or more video data is extracted, and the photo data and the one or more video data are extracted using the extracted reference information and displayed sequentially displayed using a predetermined displaying method.

This invention claims priority of Korean Patent Application No. 10-2003-0079855 filed on Nov. 12, 2003 in the Korean Intellectual Property Office and U.S. Provisional Patent Application No. 60/505,625 filed on Sep. 25, 2003 in the United States Patent and Trademark Office, the disclosures of which are incorporated herein by reference.

### BACKGROUND OF THE INVENTION

1. Field of the Invention

The present invention relates to an apparatus and a method for displaying photo and video data (hereinafter referred to as “AV data”) and a storage medium on which a program to execute the displaying method is recorded, and more particularly to management of photo and video data among multimedia data in the format of MultiPhotoVideo or MusicPhotoVideo (both of which are hereinafter referred to as “MPV”) and provision of the same to users.

2. Description of the Related Art

MPV is an industrial standard specification dedicated to multimedia titles, published by the Optical Storage Technology Association (hereinafter referred to as “OSTA”), an international trade association established by optical storage makers in 2002. Namely, MPV is a standard specification to provide a variety of music, photo and video data more conveniently or to manage and process the multimedia data. The definition of MPV and other standard specifications are available for use through the official web site (www.osta.org) of the OSTA.

Recently, media data comprising digital pictures, video, digital audio, text and the like are processed and played by means of personal computers (PC). Devices for playing the media content, e.g., digital cameras, digital camcorders, digital audio players (namely, digital audio data playing devices such as Moving Picture Experts Group Layer-3 Audio (MP3), Window Media Audio (WMA) and so on) have been in frequent use, and various kinds of media data have been produced in large quantities accordingly.

However, personal computers have mainly been used to manage multimedia data produced in large quantities; in this regard file-based user experience has been requested. In addition, when multimedia data is produced on a specified product, attributes of the data, data playing sequences, and data playing methods are produced depending upon multimedia data. If they are accessed by the personal computers, the attributes are lost and only the source data is transferred. In other words, there is a very weak inter-operability relative to data and attributes of the data between household electric goods, personal computers and digital content playing devices.

An example of the weak inter-operability will be described. A picture is captured by use of a digital camera, and data such as the sequence for attributes of a show determined by use of a slideshow function to identify the captured picture on the digital camera, time intervals between pictures, relations between pictures whose attributes determined by use of a panorama function are taken, and attributes determined by use of a consecutive photoing function are stored along with actual picture data as the source data. At this time, if the digital camera transfers pictures to a television set by use of an AV cable, a user can see multimedia data whose respective attributes are represented. However, if the digital camera is accessed to a personal computer by use of a universal serial bus (USB), only the source data is transferred to the computer and their respective attributes are lost.

As described above, it is shown that the inter-operability of the personal computer for metadata such as attributes of data stored in the digital camera is very weak or there is no inter-operability of the personal computer to the digital camera.

In order to strengthen the inter-operability relative to data between digital devices, the standardization for MPV has been in progress.

MPV specification defines Manifest, Metadata and Practice to process and play sets of multimedia data such as digital pictures, video, audio, etc. stored in a storage medium (or device) comprising an optical disk, a memory card, and a computer hard disk, or exchanged by the Internet Protocol (IP).

The standardization for MPV is currently being advanced by the OSTA (Optical Storage Technology Association) and I3A (International Imaging Industry Association). The MPV takes an open specification and mainly proposes to make it easy to process, exchange and play sets of digital pictures, video, digital audio and text and so on.

MPV is roughly classified into MPV Core-Spec (0.90WD) and Profile.

The core is composed of three basic factors such as Collection, Metadata and Identification.

The Collection has Manifest as a Root member, and it comprises Metadata, Album, MarkedAsset and AssetList, etc. The Asset refers to multimedia data described according to the MPV format, being classified into two kinds: Simple media asset (e.g., digital pictures, digital audio, text, etc.) and Composite media asset (e.g., digital picture combined with digital audio (StillWithAudio), digital pictures photoed consecutively (StillMultishotSequence), and panorama digital pictures (StillPanoramaSequence), etc.). FIG. 1 illustrates examples of StillWithAudio, StillMultishotSequence, and StillPanoramaSequence.

Metadata adopts the format of extensible markup language (XML) and has five kinds of identifiers for identification.
1. LastURL is path name and file name of a concerned asset (Path to the object),
2. InstanceID is an ID unique to each asset (unique per object: e.g., Exif 2.2),
3. DocumentID is identical to both source data and modified data,
4. ContentID is created whenever a concerned asset is used for a specified purpose, and
5. id is a local variable within metadata.

There are seven profiles: Basic profile, Presentation profile, Capture/Edit profile, Archive profile, Internet profile, Printing profile and Container profile.

MPV supports management of various file associations by use of XML metadata so as to allow various multimedia data recorded on storage media to be played. Especially, MPV supports JPEG (Joint Photographic Experts Group), MP3, WMA (Windows Media Audio), WMV (Windows Media Video), MPEG-1 (Moving Picture Experts Group-1), MPEG-2, MPEG-4, and digital camera formats such as AVI (Audio Video Interleaved) and Quick Time MJPEG (Motion Joint Photographic Experts Group) video. MPV specification-adopted discs are compatible with ISO9660 level 1, Joliet, and also multi-session CD (Compact Disc), DVD (Digital Versatile Disc), memory cards, hard discs and Internet, thereby allowing users to manage and process various multimedia data.

However, new formats of various multimedia data not defined in MPV format specification, namely new formats of assets are in need, and addition of a function to provide the multimedia data is desired.

### SUMMARY OF THE INVENTION

Accordingly, the present invention has been proposed to provide formats of new multimedia data in addition to various formats of multimedia data defined in the current MPV formats, and increase the utilization of multimedia data of various kinds by proposing a method to provide multimedia data described according to MPV formats, to users in various ways.

Consistent with an aspect of the present invention, there is provided an apparatus for displaying multimedia data described according to a MusicPhotoVideo (MPV) format, wherein it is checked whether an asset selected by a user is comprised of single photo data and one or more video data, reference information needed for displaying the photo data and the one or more video data is extracted, and the photo data and the one or more video data are extracted using the extracted reference information and sequentially displayed using a predetermined displaying method.

In an exemplary embodiment, the asset includes information on a display time when the photo data is displayed and information on a position at which the photo data is displayed. Also, the displaying method preferably comprises a first displaying method in which the video data is displayed after the photo data is displayed, and a second displaying method in which the photo data is displayed after the video data is displayed.

Consistent with another aspect of the present invention, there is provided an apparatus for displaying multimedia data described according to a MusicPhotoVideo (MPV) format, wherein it is checked whether an asset selected by a user is comprised of single video data and one or more photo data, reference information needed for displaying the video data and the photo data is extracted, and the video data and the one or more photo data are extracted using the extracted reference information and sequentially displayed using a predetermined displaying method.

In an exemplary embodiment, the asset includes information on a display time when each photo data is displayed and information on a position at which the photo data is displayed. The displaying method may comprise a first displaying method in which the photo data is displayed before the video data is displayed, a second displaying method in which the photo data is displayed while the video data is displayed, a third displaying method in which the photo data is displayed after playback of the video data is completed, and a fourth displaying method which is a combination of at least two or more displaying methods.

Consistent with another aspect of the present invention, there is provided a method for displaying multimedia data described according to a MusicPhotoVideo (MPV) format, the method comprising: checking whether an asset selected by a user is comprised of single photo data and one or more video data; extracting reference information needed for displaying the photo data and the video data; and extracting the photo data and the one or more video data using the extracted reference information and sequentially displaying the same using a predetermined displaying method.

In an exemplary embodiment, the asset includes information on a display time when the photo data is displayed and information on a position at which the photo data is displayed. Also, the displaying method preferably comprises a first displaying method in which the video data is displayed after the photo data is displayed, and a second displaying method in which the photo data is displayed after the video data is displayed.

Consistent with yet another aspect of the present invention, there is provided a method for displaying multimedia data described according to a MusicPhotoVideo (MPV) format, the method comprising: checking whether an asset selected by a user is comprised of single video data and one or more photo data; extracting reference information needed for displaying the video data and the photo data; and extracting the video data and the one or more photo data using the extracted reference information and sequentially displaying the same using a predetermined displaying method.

Here, the asset may include information on a display time when the photo data is displayed and information on a position at which the photo data is displayed, and the displaying method may comprise a first displaying method in which the photo data is displayed before the video data is displayed, a second displaying method in which the photo data is displayed while the video data is displayed, a third displaying method in which the photo data is displayed after playback of the video data is completed, and a fourth displaying method which is a combination of at least two or more displaying methods.

Consistent with a further aspect of the present invention, there is provided a recording medium on which a program for displaying multimedia data described according to a MusicPhotoVideo (MPV) format is recorded, wherein the program checks whether an asset selected by a user is comprised of single photo data and one or more video data, reference information needed for displaying the photo data and the one or more video data is extracted, and the photo data and the one or more video data are extracted using the extracted reference information and displayed sequentially displayed using a predetermined displaying method, the predetermined displaying method comprising a first displaying method in which the video data is displayed after the photo data is displayed, and a second displaying method in which the photo data is displayed after the video data is displayed.

In an exemplary embodiment, the asset includes information on a display time when the photo data is displayed and information on a position at which the photo data is displayed.

Consistent with another aspect of the present invention, there is provided a recording medium on which a program for displaying multimedia data described according to a MusicPhotoVideo (MPV) format is recorded, wherein the program checks whether an asset selected by a user is comprised of single video data and one or more photo data, reference information needed for displaying the video data and the photo data is extracted, and the video data and the one or more photo data are extracted using the extracted reference information and sequentially displayed using a predetermined displaying method, the predetermined displaying method comprising a first displaying method in which the photo data is displayed before the video data is displayed, a second displaying method in which the photo data is displayed while the video data is displayed, a third displaying method in which the photo data is displayed after playback of the video data is completed, and a fourth displaying method which is a combination of at least two or more displaying methods.

The asset may include information on a display time when the photo data is displayed and information on a position at which the photo data is displayed.

### BRIEF DESCRIPTION OF THE DRAWINGS

The above and other features and advantages of the present invention will become more apparent by describing in detail exemplary embodiments thereof with reference to the attached drawings in which:

FIG. 1 is an exemplary diagram of the type of assets specified in a MusicPhotoVideo (MPV) specification;

FIG. 2 is an exemplary diagram briefly showing a configuration of a <PhotoWithVideo> asset consistent with an embodiment of the present invention;

FIG. 3 is an exemplary diagram briefly defining a <PhotoDur> element consistent with an embodiment of the present invention;

FIG. 4 is an exemplary diagram briefly defining a <PhotoLocation> element consistent with an embodiment of the present invention;

FIG. 5A is an exemplary diagram briefly showing a type definition for a <PhotoLocation> element consistent with an embodiment of the present invention, and FIG. 5B is an exemplary diagram of a spatial relationship among <PhotoLocation> elements;

FIG. 6 is an exemplary diagram showing a type definition for a <PhotoWithVideo> element consistent with an embodiment of the present invention;

FIG. 7 is an exemplary diagram briefly showing a configuration of a <VideoWithPhoto> asset consistent with an embodiment of the present invention;

FIG. 8 is an exemplary diagram briefly defining a <PhotoDurSeq> element consistent with an embodiment of the present invention;

FIG. 9 is an exemplary diagram showing a type definition for a <VideoWithPhoto> element consistent with an embodiment of the present invention;

FIG. 10 is an exemplary diagram briefly defining a <PhotoWithVideoRef> element consistent with an embodiment of the present invention;

FIG. 11 is an exemplary diagram briefly defining a <VideoWithPhotoRef> element consistent with an embodiment of the present invention;

FIG. 12 is an exemplary diagram briefly defining a <PhotoRefGroup> consistent with an embodiment of the present invention;

FIG. 13 is a flowchart illustrating a method for playing back a ‘PhotoWithVideo’ asset consistent with an embodiment of the present invention; and

FIGS. 14A and 14B are a flowchart illustrating a method for playing back a ‘VideoWithPhoto’ asset consistent with an embodiment of the present invention.

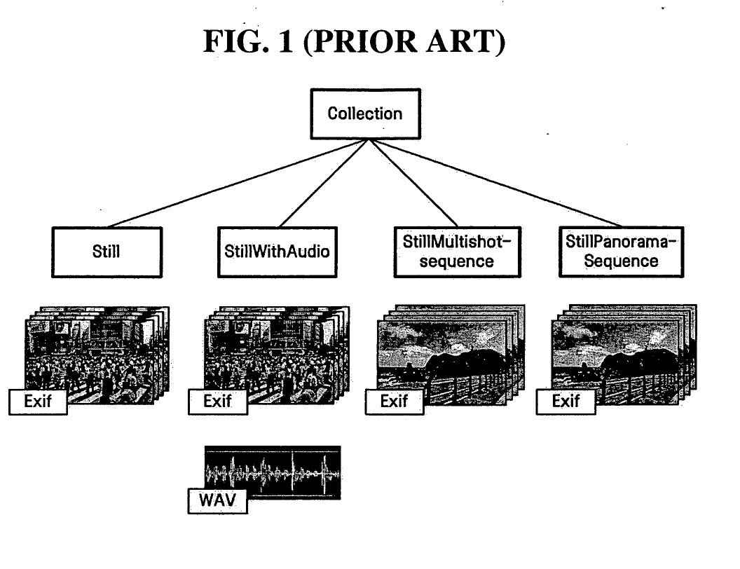

### DETAILED DESCRIPTION OF THE INVENTION

Hereinafter, an apparatus and a method for displaying photo and video data described according to MPV formats consistent with an aspect of the present invention will be described in more detail with reference to the accompanying drawings.

In the present invention, XML is used to provide multimedia data according to a MPV format. Thus, the present invention will be described according to XML schema.

Various multimedia data are provided herein by proposing new assets of ‘AudioWithVideo’ and ‘VideoWithAudio’ not provided by the OSTA. To describe the new assets, the following terms ‘smpv’ and ‘mpv’ are used to refer to ‘namespace’ in XML, wherein the former indicates a namespace relative to a new element proposed in the present invention and the latter indicates a namespace relative to an element proposed by the OSTA. The definitions and examples of these new assets will be described.

1. ‘PhotoWithVideo’ Asset

‘PhotoWithVideo’ is an asset that combines a single photo asset with at least one video asset. If the asset is described using XML, it can be referred to as a <PhotoWithVideo> element. The photo asset and the video asset are treated as an element in a file described using XML.

The photo asset can be represented by <mpv:StillRef>, <mpv:StillMultiShotSequenceRef>, and <mpv:StillPanoramaRef>, and the video asset can be represented by <smpv:VideoPartRef>, <mpv:VideoRef>, <smpv:VideoWithAudioRef>, and <smpv:AudioWithVideoRef>.

The <VideoPartRef> element refers a <VideoPart> element, which represents a part of the Video asset. The <VideoPart> element includes children elements defined by <smpv:start>, <smpv:stop> and <smpv:dur>. At least one among the children elements must have a specific value.

The <SMPV:start> element can be defined by <xs:element name=“SMPV:start” type=“xs:long” minOccurs=“0”/>. A start time for a part of the whole time of the referenced video asset is represented in units of seconds. If no value is given, the start time can be calculated using the following equation on the basis of <SMPV:stop> and <SMPV:dur> values: [SMPV:start]=[SMPV:stop]−[SMPV:dur]. If the <SMPV:stop> or <SMPV:dur> value is not specified, the <SMPV:start> value becomes zero.

The <SMPV:stop> element can be defined by <xs:element name=“SMPV:stop” type=“xs:long” minOccurs=“0”/>. A stop time for a part of the whole time of the referenced video asset is represented in units of seconds. If no value is given, the stop time can be calculated using the following equation on the basis of <SMPV:start> and <SMPV:dur> values: [SMPV:stop]=[SMPV:start]+[SMPV:dur]. If the <SMPV:dur> value is not specified but the <SMPV:start> value is specified, the <SMPV:stop> value equals the stop time of the reference asset. On the other hand, if the <SMPV:start> is not specified but the <SMPV:dur> value is specified, the <SMPV:stop> value equals the <SMPV:dur> value.

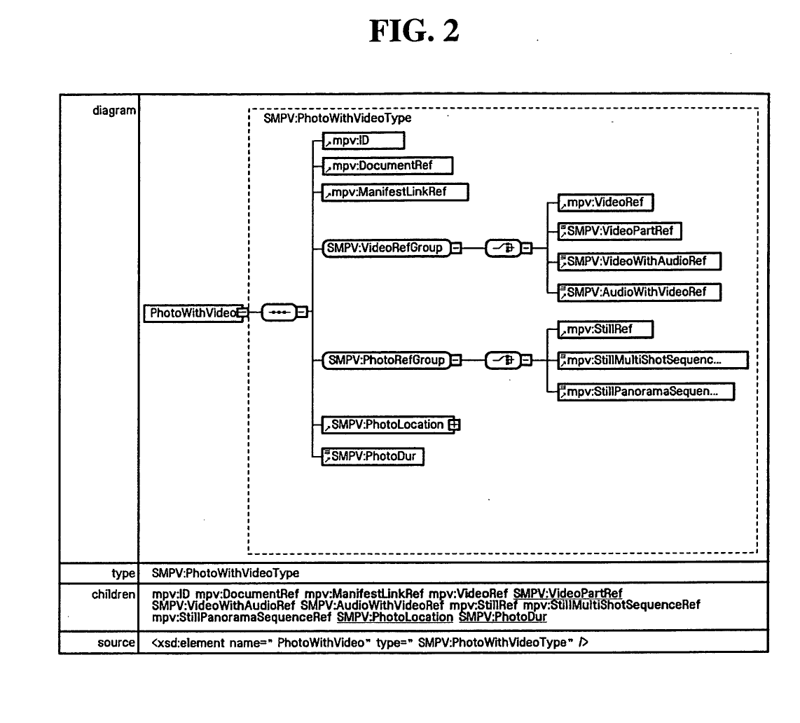

The <SMPV:dur> element can be defined by <xs:element name=“SMPV:dur” type=“xs:long” minOccurs=“0”/>, which represents an actual play time out of the overall time of the referenced video asset. If the <SMPV:dur> value is not given, it can be calculated as follows: [SMPV:dur]=[SMPV:stop]−[SMPV:start]. FIG. 2 schematically defines a configuration of a <PhotoWithVideo> asset.

Referring to the diagram of the <PhotoWithVideo> element in FIG. 2, the <PhotoWithVideo> element comprises multiple children elements using ‘mpv’ and ‘smpv’ as namespaces.

Here, since the element using ‘mpv’ as a namespace has been described on OSTA's website at www.osta.org, an explanation thereof will not be given. Thus, the elements using ‘smpv’ as a name space will now be described.

(1) <PhotoDur> Element

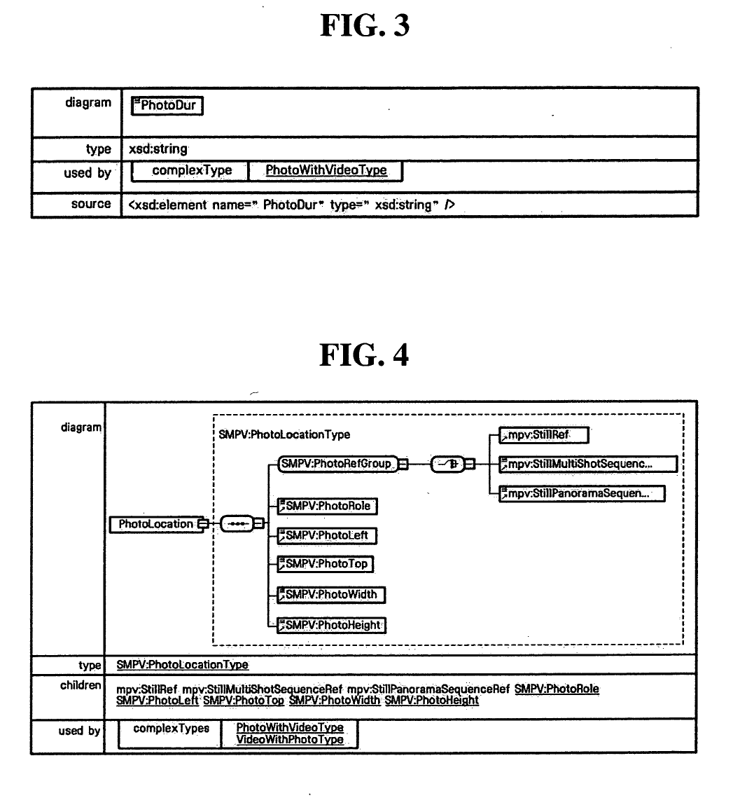

A <PhotoDur> element represents a time in which a single photo asset is displayed in units of seconds. The <PhotoDur> element is an essential element for defining the <PhotoWithVideo> element. FIG. 3 briefly shows the <PhotoDur> element.

(2) <PhotoLocation> Element

A <PhotoLocation> element defines the position of a photo asset. That is, the <PhotoLocation> element represents the temporal or spatial position in which a single photo asset is displayed while multiple video assets are displayed. FIG. 4 briefly defines the <PhotoLocation> element. In FIG. 4, a <PhotoRole> element among the children elements forming the <PhotoLocation> element represents the temporal relationship.

The <PhotoLocation> element basically operates in the ‘PhotoWithVideo’ asset. Suitable examples of the <PhotoRole> element include “Title” representing that a photo asset should be displayed before the reproduction of the corresponding video asset starts and “End” representing that a photo asset should be displayed after the reproduction of the corresponding video asset ends.

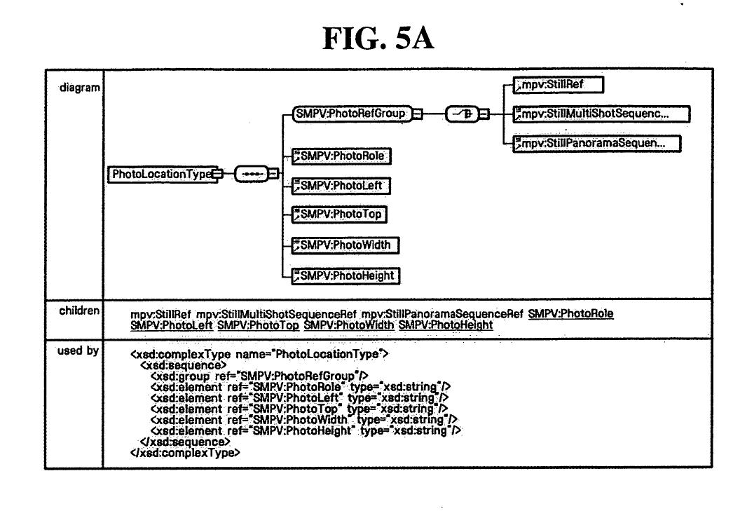

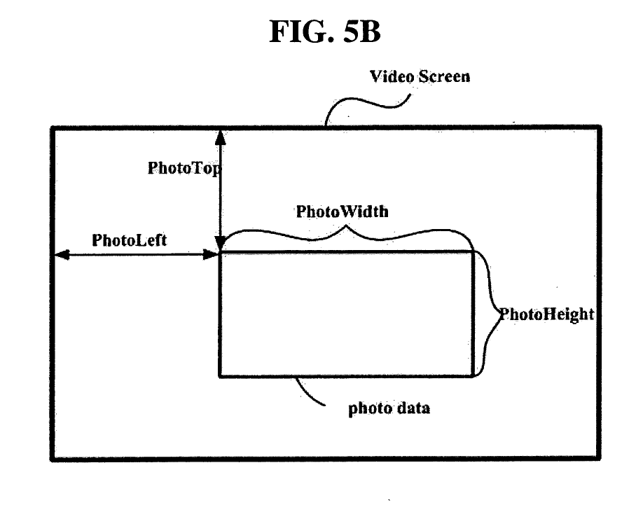

In general, <PhotoLeft> element, <PhotoTop> element, <PhotoWidth> element, and <PhotoHeight> element representing the spatial relationship of the photo asset are rarely used in the ‘PhotoWithVideo’ element. FIG. 5A shows a type definition of the <PhotoLocation> element, and FIG. 5B shows the positional relationship between each of a <PhotoLeft> element, a <PhotoTop> element, a <PhotoWidth> element, and a <PhotoHeight> element forming the <PhotoLocation> element.

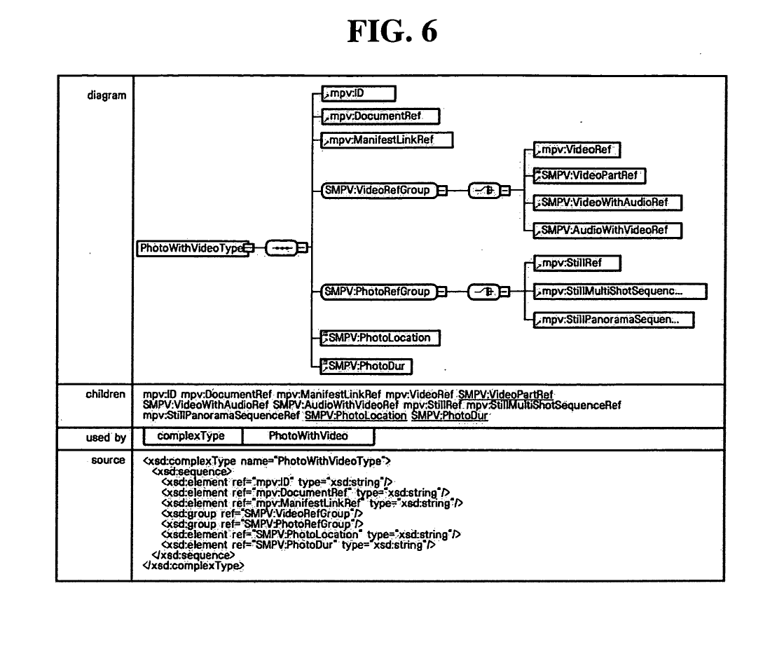

FIG. 6 shows a type definition of the <PhotoWithVideo> element.

A method of defining the PhotoWithVideo asset using the elements described above will now be described by way of examples.

### EXAMPLE 1

```
<SMPV:PhotoWithVideo>
      <MPV:StillRef>S001</MPV:StillRef>
      <MPV:VideoRef>V001</MPV:VideoRef>
      <SMPV:PhotoDur>5</SMPV:PhotoDur>
      <SMPV:PhotoLocation>
          <SMPV:PhotoRole>Title</SMPV:PhotoRole>
      </SMPV:PhotoLocation>
</SMPV:PhotoWithVideo>
```

‘Example 1’ defines that photo data referred to as ‘S001’ should be displayed for 5 seconds before video data referred to as ‘V001’ is played back. For example, the photo data referred to as ‘S001’ can be used in displaying the played video title or messages relating to data-copy.

### EXAMPLE 2

```
<SMPV:PhotoWithVideo>
      <MPV:StillRef>S002</MPV:StillRef>
      <MPV:VideoRef>V001</MPV:VideoRef>
      <SMPV:PhotoDur>2</SMPV:PhotoDur>
      <SMPV:PhotoLocation>
          <SMPV:PhotoRole>End</SMPV:PhotoRole>
      </SMPV:PhotoLocation>
</SMPV:PhotoWithVideo>
```

‘Example 2’ defines that photo data referred to as ‘S002’ should be displayed for 2 seconds after video data referred to as ‘V001’ is reproduced.

2. ‘VideoWithPhoto’ Asset

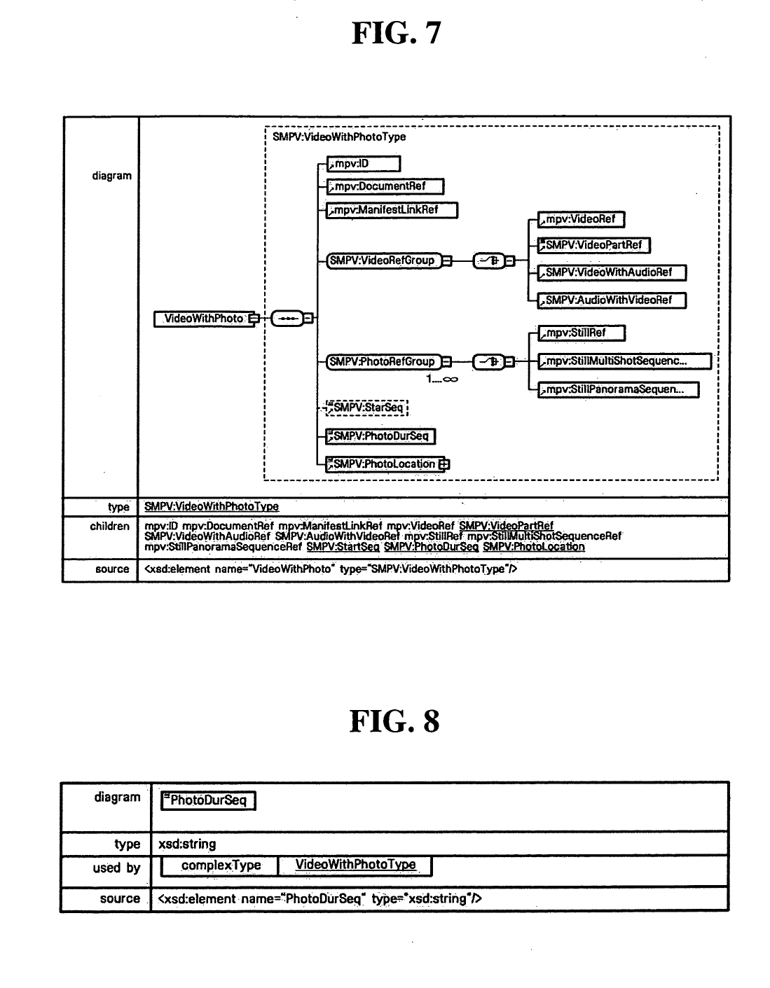

‘VideoWithPhoto’ is an asset that combines single video asset with one or more photo assets. The asset described using XML can be referred to as the <VideoWithPhoto> element. The photo assets and the video asset described using XML are treated as elements. In this case, the photo asset can be represented by ‘mpv:StillRef’, ‘mpv:StillMultiShotSequenceRef’, or ‘mpv:StillPnoramaRef’ and the video asset can be represented by ‘SMPV:VideoPartRef’, ‘mpv:VideoRef’, ‘SMPV:VideoWithAudioRef’, or ‘SMPV:AudioWithVideoRef’. The ‘VideoWithPhoto’ asset is used for displaying a plurality of photo data while a single video data is playing. Thus, different kinds of photo data can be displayed a predetermined time before, while and after playing the video data. FIG. 7 schematically shows a structure of the ‘VideoWithPhoto’ element. As shown in FIG. 7, the <VideoWithPhoto> element includes a plurality of elements using ‘mpv’ and ‘smpv’ as namespaces, respectively.

Elements having ‘mpv’ as namespace are described in the official homepage of OSTA (www.osta.org) proposing MPV specification, description thereof will be omitted herein. Accordingly, only elements having ‘smpv’ as namespace will be described below, with an exception of contents having been described above in the section of the ‘PhotoWithVideo’ asset.

(1) <PhotoDurSeq> Element

A <PhotoDurSeq> element denotes the display duration of each photo data. The <PhotoDurSeq> element is a relative time value represented in units of seconds. The playing time can be represented in decimal representation. When a value of the <PhotoDurSeq> element is not set, it is not possible to know how long it is displayed. Thus, the value of the <PhotoDurSeq> element should be defined.

The value of the <PhotoDurSeq> element will be described briefly as follows:
PhotoDurSeq=<clock-value>(“;”<clock-value>); [Equation 1]
clock-value=(<seconds>|<unknown-dur>) [Equation 2]
unknown-dur=the empty string [Equation 3]
seconds=<decimal number>(<decimal number>). [Equation 4]

[Equation 1] means that the value of the <PhotoDurSeq> element can be represented by ‘clock-value’ and, when there are two or more photo data, a display time of each photo data can be distinguished using “;”.

[Equation 2] means that the ‘clock-value’ in [Equation 1] can be represented by ‘seconds’ or ‘unknown-dur’.

[Equation 3] means that the ‘unknown-dur’ in [Equation 2] represents that the ‘clock-value’ is not set.

[Equation 4] means that the value of ‘seconds’ in [Equation 2] is represented by a decimal number and the display time of pertinent photo data is represented by a decimal point.

For example, the ‘clock-value’ of ‘12.2’ means that the display time of the pertinent photo data is 12.2 seconds. As another example, the ‘clock-value’ of ‘20;8.9’ means that the number of pertinent photo data is 2, the playback time of the first photo data is 20 seconds and the playback time of the second photo data is 8.9 seconds.

FIG. 7 defines a <StartSeq> element, which is a child element of <VideoWithPhoto> element, in which the value of the <StartSeq> element represents the time when the video data starts to be played back. Here, the <StartSeq> element is represented in units of seconds and is a relative time value based on the time when the video data starts to be played back, which is also be given by decimal representation. For example, when the value of <StartSeq> element is not set, it is assumed that the corresponding value is 0 seconds. In other words, the start time corresponds to the time when the pertinent video data starts to be played back. If the value of the <StartSeq> element is greater than the overall playback time of the pertinent video data, the photo data is played back after playback of the pertinent video data is completed. In this case, it is assumed that the value of the <StartSeq> element is ‘0’. The <StartSeq> of a negative (−) value means that the photo data is displayed before the video data is played back. In this case, therefore, a value of a <PhotoRole> element must be set. If the value of the <StartSeq> is positive (+) and is less than the overall playback time of the pertinent video data, the photo data and the video data may overlap each other. Thus, the spatial position of the <PhotoLocation> element must be defined. FIG. 8 briefly describes the <PhotoDurSeq> element.

A method of defining the ‘VideoWithPhoto’ asset using the above-described elements will now be described by way of examples.

### EXAMPLE 1

```
<SMPV:VideoWithPhoto>
      <MPV:StillRef>S001</MPV:StillRef>
      <MPV:VideoRef>V001</MPV:VideoRef>
      <SMPV:PhotoDur>5</SMPV:PhotoDur>
      <SMPV:PhotoLocation>
          <SMPV:PhotoRole>Title</SMPV:PhotoRole>
      </SMPV:PhotoLocation>
</SMPV:VideoWithPhoto>
```

‘Example 1’ defines that photo data referred to as ‘S001’ should be displayed for 5 seconds before video data referred to as ‘V001’ is played back. For example, the photo data referred to as ‘S001’ can be used in displaying the played video title or messages relating to data-copy.

### EXAMPLE 2

```
<SMPV:VideoWithPhoto>
          <MPV:StillRef>S001</MPV:StillRef>
          <MPV:StillRef>S002</MPV:StillRef>
          <MPV:StillRef>S003</MPV:StillRef>
          <MPV:VideoRef>V001</MPV:VideoRef>
          <SMPV:PhotoDurSeq>5;3;7</SMPV:PhotoDurSeq>
          <SMPV:StartSeq>−5;5;10</SMPV:StartSeq>
          <SMPV:PhotoLocation>
              <MPV:StillRef>S001</MPV:StillRef>
              <SMPV:PhotoRole>Title</SMPV:PhotoRole>
          </SMPV:PhotoLocation>
          <SMPV:PhotoLocation>
              <MPV:StillRef>S002</MPV:StillRef>
              <SMPV:PhotoLeft>0</SMPV:PhotoLeft>
              <SMPV:PhotoTop>0</SMPV:PhotoTop>
              <SMPV:PhotoWidth>50</SMPV:PhotoWidth>
              <SMPV:PhotoHeight>50</SMPV:PhotoHeight>
          </SMPV:PhotoLocation>
          <SMPV:PhotoLocation>
              <MPV:StillRef>S003</MPV:StillRef>
              <SMPV:PhotoRole>End</SMPV:PhotoRole>
          </SMPV:PhotoLocation>
      </SMPV:PhotoWithVideo>
```

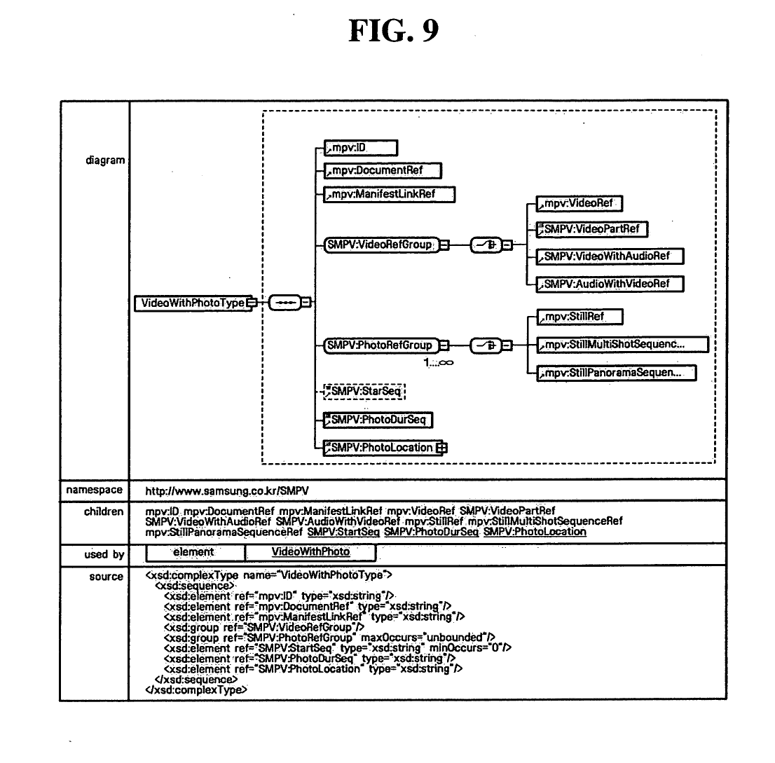

‘Example 2’ defines that photo data referred to as ‘S001’ should be displayed for 5 seconds before video data referred to as ‘V001’ is played back. 5 seconds after the video data is displayed, the photo data referred to as ‘S002’ is played back for 3 seconds. Thereafter, when the playback of the video data is completed, the photo data referred to as ‘S003’ is played back for 7 seconds. FIG. 9 illustrates a type definition for a <VideoWithPhoto> element.

(2) <PhotoWithVideoRef>

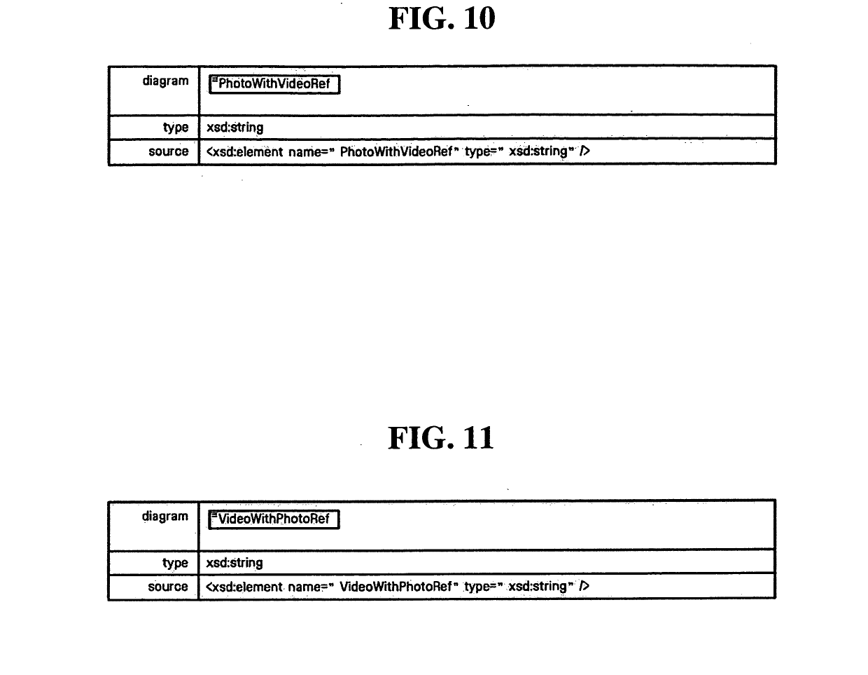

A <PhotoWithVideoRef> element is structured to make reference to the <PhotoWithVideo> element. FIG. 10 briefly describes the <PhotoWithVideoRef> element.

(3) <VideoWithPhotoRef>

A <VideoWithPhotoRef> element is structured to make reference to <VideoWithPhoto> element. FIG. 11 briefly describes the <VideoWithPhotoRef> element.

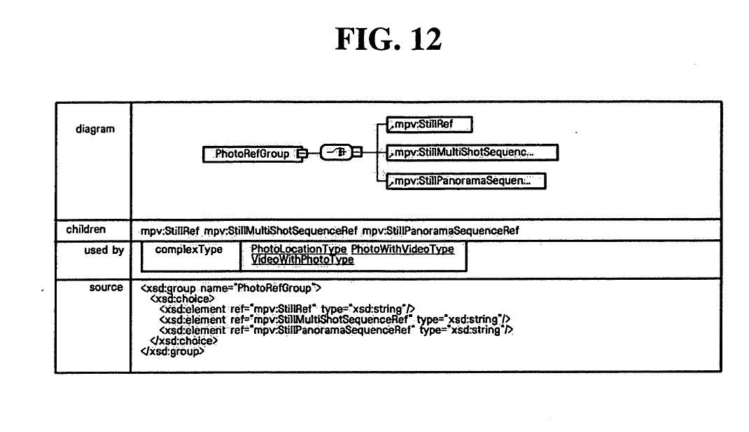

Meanwhile, the present invention defines a reference group for referencing photo assets, which is referred to as ‘PhotoRefGroup’ and is briefly described in FIG. 12.

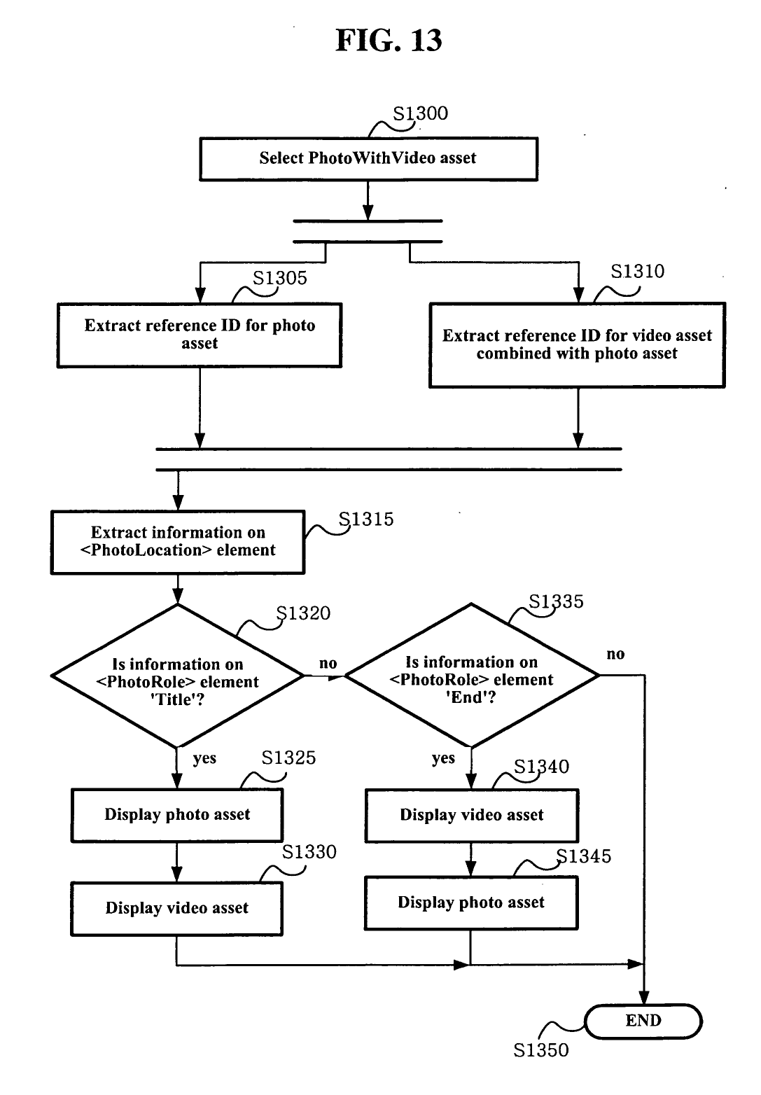

FIG. 13 is a flowchart illustrating a process of playing back a ‘PhotoWithVideo’ asset consistent with an embodiment of the present invention, particularly illustrating a process for displaying ‘PhotoWithVideo’ in which a photo asset is combined with a video asset.

When a user runs software for MVP file playback and selects the ‘PhotoWithVideo’ asset in a particular album in step S1300. Then, a thread or a child processor is created and information on the respective photo assets and information on the video assets are collected.

In other words, a reference ID for the photo assets forming the user's selected ‘PhotoWithVideo’ asset is extracted in step S1305. Then, information on the photo asset is extracted from AssetList using the extracted reference ID, although not shown in the flowchart. In another thread or child processor, first, a reference ID for a video asset combined with the photo asset is extracted in step S1310. Then, information on the video asset is extracted from AssetList using the reference ID for the video asset, although not shown in the flowchart.

When the information on the respective photo assets and the information on the video assets are both extracted, information on the <PhotoLocation> element described in the MPV file is extracted in step S1315. In other words, it is necessary to decide when to display the photo asset during playback of the video asset.

If the information on the <PhotoLocation> element corresponds to ‘Title’, the photo asset is first displayed and the video asset is then displayed in steps S1320, 1325 and 1330.

If the information on the <PhotoLocation> element corresponds to ‘End’, the video asset is first displayed and the photo asset is then displayed in steps S1335, 1340 and 1345.

If the information on the <PhotoLocation> element is not ‘Title’ nor ‘End’, no asset is displayed and the process is terminated. That is, the process returns to a software manner, in step S1350.

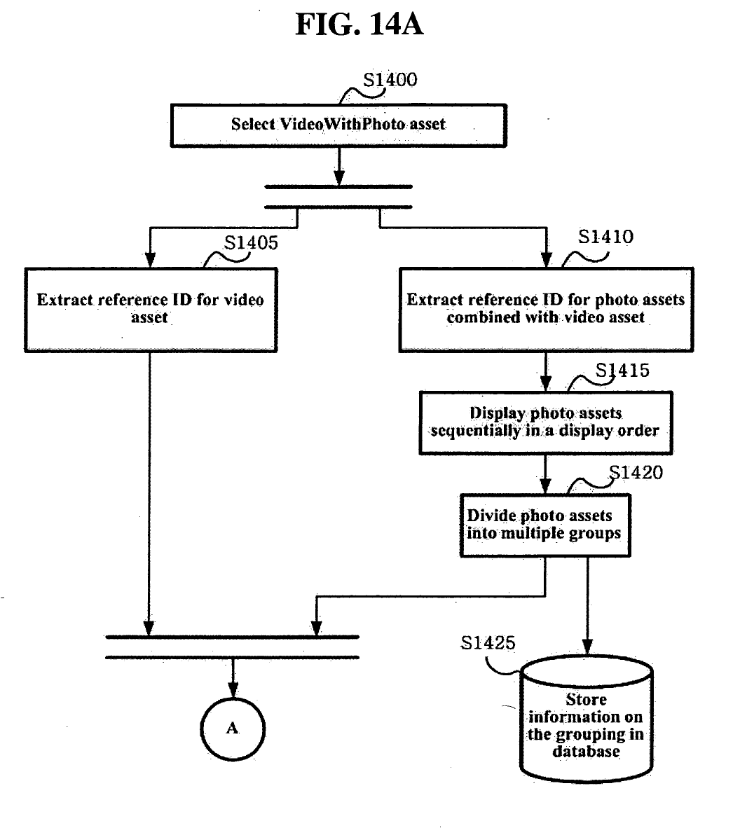

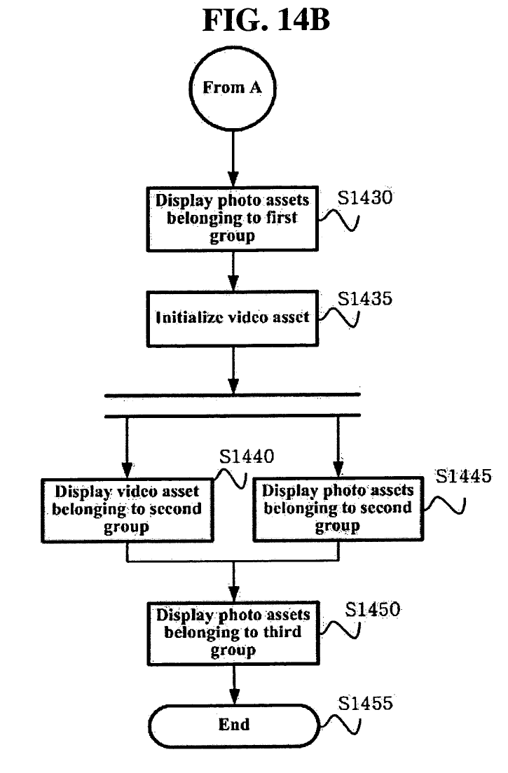

FIGS. 14A and 14B are a flowchart illustrating a process of playing back a ‘VideoWithPhoto’ asset consistent with an embodiment of the present invention.

A user executes the software capable of executing any file written according to the MPV format and selects ‘VideoWithPhoto’ asset in a certain album S1400. Then, a thread or a child processor is generated, which collects information on photo assets and video assets.

In other words, a reference ID for the video asset forming the user's selected ‘VideoWithPhoto’ asset is extracted in step S1405. Then, information on the video asset is extracted from AssetList using the extracted reference ID, although not shown in the flowchart. In another thread or child processor, first, a reference ID for a photo asset combined with the video asset is extracted in step S1410. Then, information on the photo asset is extracted from AssetList using the extracted reference ID for the photo asset, although not shown in the flowchart. At this time, a plurality of photo assets forming the ‘VideoWithPhoto’ asset are arranged using the information on the <PhotoDurSeq> element, <StartSeq> element or <PhotoLocation> element sequentially in a display order in step S1415.

In step S1420, the plurality of photo assets are grouped into several groups: a first group comprised of photo assets displayed before the video asset forming the ‘VideoWithPhoto’ asset is played back; a second group comprised of photo assets displayed while the video asset is played back; and a third group comprised of photo assets displayed after the video asset is played back. At this time, information on the grouping can be stored in a separate database in step S1425.

When steps S1405 and S1420 are terminated, in step S1430, the photo assets belonging to the first group are first displayed on information on the grouping performed in step S1420. Then, a video asset to be played back is initialized in step S1435, and the video asset and the photo assets belonging to the second group are simultaneously displayed according to predetermined display information in step S1440 and 1445.

If the playback of the video asset is completed, the photo assets belonging to the third group is displayed in step S1450.

Multimedia data provided in MPV format can be described in the form of XML documents, which can be changed to a plurality of application documents according to stylesheets applied to the XML documents. In the present invention, the stylesheets to change an XML document to an HTML document has been applied, whereby a user is allowed to manage audio and video data through a browser. In addition, the stylesheets to change the XML document to a WML (Wireless Markup Language) or cHTML (Compact HTML) document may be applied, thereby allowing the user to access audio and video data described in the MPV format through mobile terminals such as a personal digital assistant (PDA), a cellular phone, a smart phone and so on.

As described above, the present invention provides users with a new form of multimedia data assets in combination of audio data and video data, thereby allowing the users to generate and use various multimedia data described in the MPV format.

Although the present invention has been described in connection with the exemplary embodiments thereof shown in the accompanying drawings, they are mere examples of the present invention. It can also be understood by those skilled in the art that various changes, modifications and equivalents thereof can be made thereto. Accordingly, the true technical scope of the present invention should be defined by the appended claims.

1. An apparatus for displaying multimedia data-described according to a MusicPhotoVideo (MPV) format, the apparatus comprising:
a memory under control of a processor, the memory comprising software enabling the apparatus to:
check whether an asset selected by a user is comprised of single photo data and one or more video data;
extract reference information needed for displaying the photo data and the one or more video data;
extract the photo data and the one or more video data using the extracted reference information; and
sequentially display the photo data and the one or more video data using a predetermined displaying method.

2. The apparatus of claim 1, wherein the asset comprises information on a display time when the photo data is displayed and information on a position at which the photo data is displayed.

3. The apparatus of claim 1, wherein the displaying method comprises a first displaying method in which the video data is displayed after the photo data is displayed, and a second displaying method in which the photo data is displayed after the video data is displayed.

4. An apparatus for displaying multimedia data described according to a MusicPhotoVideo (MPV) format, the apparatus comprising:
a memory under control of a processor, the memory comprising software enabling the apparatus to:
check whether an asset selected by a user is comprised of single video data and one or more photo data;
extract reference information needed for displaying the video data and the photo data;
extract the video data and the one or more photo data using the extracted reference information; and
sequentially display the photo data and the one or more video data using a predetermined displaying method.

5. The apparatus of claim 4, wherein the asset comprises information on a display time when each photo data is displayed and information on a position at which the photo data is displayed.

6. The apparatus of claim 4, wherein the displaying method comprises a first displaying method in which the photo data is displayed before the video data is displayed, a second displaying method in which the photo data is displayed while the video data is displayed, a third displaying method in which the photo data is displayed after playback of the video data is completed, and a fourth displaying method which is a combination of at least two or more displaying methods.

7. A method for displaying multimedia data described according to a MusicPhotoVideo (MPV) format, the method comprising:
checking whether an asset selected by a user is comprised of single photo data and one or more video data;
extracting reference information needed for displaying the photo data and the video data; and
extracting the photo data and the one or more video data using the extracted reference information and sequentially displaying the same using a predetermined displaying method.

8. The method of claim 7, wherein the asset comprises information on a display time when the photo data is displayed and information on a position at which the photo data is displayed.

9. The method of claim 7, wherein the displaying method comprises a first displaying method in which the video data is displayed after the photo data is displayed, and a second displaying method in which the photo data is displayed after the video data is displayed.

10. A method for displaying multimedia data described according to a MusicPhotoVideo (MPV) format, the method comprising:
checking whether an asset selected by a user is comprised of single video data and one or more photo data;
extracting reference information needed for displaying the video data and the photo data; and
extracting the video data and the one or more photo data using the extracted reference information and sequentially displaying the same using a predetermined displaying method.

11. The method of claim 10, wherein the asset comprises information on a display time when the photo data is displayed and information on a position at which the photo data is displayed.

12. The method of claim 10, wherein the displaying method comprises a first displaying method in which the photo data is displayed before the video data is displayed, a second displaying method in which the photo data is displayed while the video data is displayed, a third displaying method in which the photo data is displayed after playback of the video data is completed, and a fourth displaying method which is a combination of at least two or more displaying methods.

13. A computer readable recording medium on which a program for displaying multimedia data described according to a MusicPhotoVideo (MPV) format is recorded, the program enabling a processor to:
check whether an asset selected by a user is comprised of single photo data and one or more video data;
extract reference information needed for displaying the photo data and the one or more video data;
extract the photo data and the one or more video data using the extracted reference information; and
sequentially display the photo data and the one or more video data using a predetermined displaying method,
wherein the predetermined displaying method comprises a first displaying method in which the video data is displayed after the photo data is displayed, and a second displaying method in which the photo data is displayed after the video data is displayed.

14. The computer readable recording medium of claim 13, wherein the asset comprises information on a display time when the photo data is displayed and information on a position at which the photo data is displayed.

15. A computer readable recording medium on which a program for displaying multimedia data described according to a MusicPhotoVideo (MPV) format is recorded, the program enabling a processor to:
check whether an asset selected by a user is comprised of single video data and one or more photo data;
extract reference information needed for displaying the video data and the photo data;
extract the video data and the one or more photo data using the extracted reference information; and
sequentially display the video data and the one or more photo data using a predetermined displaying method,
wherein the predetermined displaying method comprises a first displaying method in which the photo data is displayed before the video data is displayed, a second displaying method in which the photo data is displayed while the video data is displayed, a third displaying method in which the photo data is displayed after playback of the video data is completed, and a fourth displaying method which is a combination of at least two or more displaying methods.

16. The computer readable recording medium of claim 15, wherein the asset comprises information on a display time when each photo data is displayed and information on a position at which the photo data is displayed.
